(19) United States
(12) Patent Application Publication
(10) Pub. No.: US 2010/0082242 A1
(43) Pub. Date: Apr. 1, 2010

(54) SYSTEM AND METHOD FOR INTUITIVE POI (POINT OF INTERESTS) MAP SEARCH

(76) Inventor: Jong Am PARK, Los Angeles, CA (US)

Correspondence Address: IPLA P.A., 3550 WILSHIRE BLVD., 17TH FLOOR, LOS ANGELES, CA, 90010, US

(21) Appl. No.: 12/243,761

(22) Filed: Oct. 1, 2008

(51) Int. Cl. G01C 21/00; G06F 7/06; G06F 17/30

(52) U.S. Cl. 701/208; 707/E17.014; 707/E17.018

(57) ABSTRACT

An intuitive POI map search comprises steps of: presenting a graphical map; selecting an area portion of the graphical map; determining and storing geocodes for the selected portion; providing search keywords; performing a search on a database using the stored geocodes and the provided search keywords; and displaying the search results. An intuitive POI map search system includes a region selector, a geocode taker, an address extractor, a keyword provider, and a search engine. The region selector selects a second geographic region out of a first geographic region. The geocode taker obtains geocodes for points inside the second geographic region. The address extractor obtains addresses out of the corresponding geocodes. The keyword provider provides search keywords. The search engine performs searches on a database with the geocodes, the extracted address, and the search keywords.

### BACKGROUND OF THE INVENTION

The invention relates to a system and method for intuitive POI map search in the Internet environment.

The advent of Internet has evolved maps to mean more than just a tome of pages with every word or line stuck in place. An online map has become crucial part of search tools to Internet users since it is widely available on a computer screen or a mobile communication device. Online maps provide present information in a point of interests (POI) search. The POI search in the prior arts, however, is usually based on a textual search on a vast ocean of information, which is accessible through the Internet. Map search has been acceptable when related to the whole map on the flood of information on the Internet.

A demand on the market is to provide an online map search in an extensive mode beyond the geographical search scope, where a coffee shop or a two-bed apartment around a specific location may be searchable instantly while in search of the location during Internal map search.

This invention is directed to solve the problems of prior arts and satisfy the long-felt need of the community with an improved method and system for intuitive POI map search.

### SUMMARY OF THE INVENTION

The invention is contrived to solve the disadvantages of the prior art. An objective of the invention is to provide a system and method for intuitive POI map search.

Another objective of the invention is to provide a method for intuitive POI map search, coordinating a map search with a detail-oriented information search in a single screen mode.

Still another objective of the invention is to provide a system for intuitive POI map search, which performs POI map search by enabling a community life search on a selected sub-region.

In order to achieve these and other objectives, an aspect of the invention provides a method for intuitive POI map search. The method comprises steps of: presenting a graphical map representing a first geographic region, the graphical map comprising embedded mesh associated with coordinates, wherein a plurality of points and sub-regions of the embedded mesh are mapped to a plurality of geocodes representing the first geographic region; selecting an area portion of the graphical map representing a second geographical region, wherein the second geographical region comprises a sub-region of the first geographical region; determining and storing geocodes for the selected portion, each of the geocodes comprising a plurality of geospatial attributes; providing a plurality of search keywords; performing a search on a database using the stored geocodes and the provided search keywords; and displaying the search results, wherein the search results comprises information on the second geographical region.

The embedded mesh may comprise a plurality of meshes of different resolutions, and the plurality of meshes of different resolutions may be mapped to one another. The step of presenting may comprise a step of mapping the plurality of meshes of different resolutions to one another using a data structure. The step of selecting may comprise displaying the area portion of the graphical map using a plurality of border lines. The step of selecting may comprise displaying the area portion of the graphical map using a plurality of mosaic patterns having different colors.

The area portion may have geometrical shapes, and the geometrical shapes may comprise a rectangle, a circle, an ellipse, and polygons. The area portion may have a plurality of irregular shapes. Each of the irregular shapes may represent a plurality of levels of administrative districts and service areas. Each of the administrative districts may be associated with a plurality of addresses corresponding to the first geographic region.

In an embodiment, each of the geometrical shapes may comprise a plurality of coordinates for points on the graphical map. The step of selecting may comprise a step of defining the area portion of the graphical map with a mouse-and-cursor device. The step of selecting may comprise a step of defining the area portion of the graphical map with a touch screen device. Each of geocodes may correspond to a corresponding point on the geometrical map, and the spatial attributes may comprise a Geocode Format Registry Number, a latitude, a longitude, a altitude, a date, a local time, and a global time in coordinated universal time (UTC) format. The step of determining may comprise converting a geocode to a corresponding address. The step of providing may comprise a step of providing the plurality of search keywords using a keyboard, a touchpad, or a pull-down menu.

For a better performance, the database may be organized according to geocodes, addresses, and a plurality of points of interest. The step of displaying may comprise representing the plurality of points of interest with colors, symbols, or clickable texts or symbols. The colors may be chosen according to property of the points of interest. The search results may comprise a plurality of points of interest, and the plurality of points of interest may be represented by texts, symbols, or clickable buttons on the graphical map. The search keywords may comprise categories, and wherein the database is organized according to the categories and the search keywords.

In another embodiment, the method may further comprise steps of: storing a plurality of search results for a plurality of second geographical regions, wherein the plurality of search results are obtained by repeating the state of performing; and displaying at least one stored search result of the plurality of search results corresponding to a location where a user uses the method automatically. The step of displaying may comprise a step of determining the location with a global positioning system (GPS). The method may further comprise a step of printing the displayed search result on a physical medium upon a request from the user.

Another aspect of the invention provides an intuitive POI map search system, the system comprising a region selector, a geocode taker, an address extractor, a keyword provider, and a search engine. The region selector is configured for selecting a second geographic region out of a first geographic region. The geocode taker is configured for obtaining geocodes for a plurality of points inside the second geographic region. The address extractor is configured for obtaining addresses out of the corresponding geocodes for the plurality of points inside the second geographic region. The keyword provider is configured for providing a plurality of search keywords.

The search engine is configured for performing one or more searches on a database with the geocodes, the extracted address, and the search keywords for a plurality of points of interest in the second geographic region. The region selector may comprise a mouse-and-cursor device or touch screen device. The system may further comprise a display configured for displaying a graphical map corresponding to the geographic regions. The system may further comprise a central processing unit configured for controlling the region selector, the geocode taker, the address extractor, the keyword provider, the search engine, and the display.

The region selector may be further configured for defining the second geographic region of geometrical shapes or irregular shapes. The region selector may be further configured for selecting a plurality of separate points on the first geographic region and forming the second geographic region by connecting the selected separate points. The region selector may be further configured for selecting one out of predetermined set of sub-regions of the first geographic region, and the predetermined set of sub-regions may be provided and retrieved from the database.

In a preferred mode, each of the predetermined set of sub-regions may comprise an administrative district, a service area, or a demographic map. The geocodes and the corresponding addresses may be provided by the database. The plurality of search keywords may be used for providing category words, class words, and subject words of the database so as to be used by the search engine.

The intuitive POI map search system may further comprise: a global positioning system (GPS) configured to determine a location of a user; a storing device configured to store a plurality of search results for a plurality of second geographical regions from the search engine; a display configured to display one of the stored search results of a second geographical region corresponding to a present location of the user automatically; and a printer configured to print the displayed search result of the second geographical region.

The advantages of the invention include that the intuitive POI map search method provides search results by coordinating a map search with a detail-oriented information search in a single screen mode, and that the intuitive POI map search a community life search on a selected sub-region in a hybrid search mode.

Although the invention is briefly summarized, the fuller understanding of the invention can be obtained by the following drawings, detailed description and appended claims.

### BRIEF DESCRIPTION OF DRAWINGS

These and other features, aspects and advantages of the invention will become better understood with reference to the accompanying drawings, wherein:

FIG. 1 is a flowchart illustrating a method for intuitive POI map search according to an embodiment of the invention;

FIG. 2 is a conceptual diagram illustrating meshes of different resolutions associated with a graphical map according to an embodiment of the invention;

FIG. 3 is a schematic diagram of a first geographical region having second geographical regions according to an embodiment of the invention;

FIG. 4 is a schematic diagram of a geographical map and input devices for providing search keywords according to an embodiment of the invention;

FIG. 5 is a schematic diagram of a second geographical region having search results according to an embodiment of the invention;

FIG. 6 is a conceptual diagram illustrating function of a search engine according to an embodiment of the invention; and

FIG. 7 is a block diagram illustrating an intuitive POI map search system according to an embodiment of the invention.

### DETAILED DESCRIPTION EMBODIMENTS OF THE INVENTION

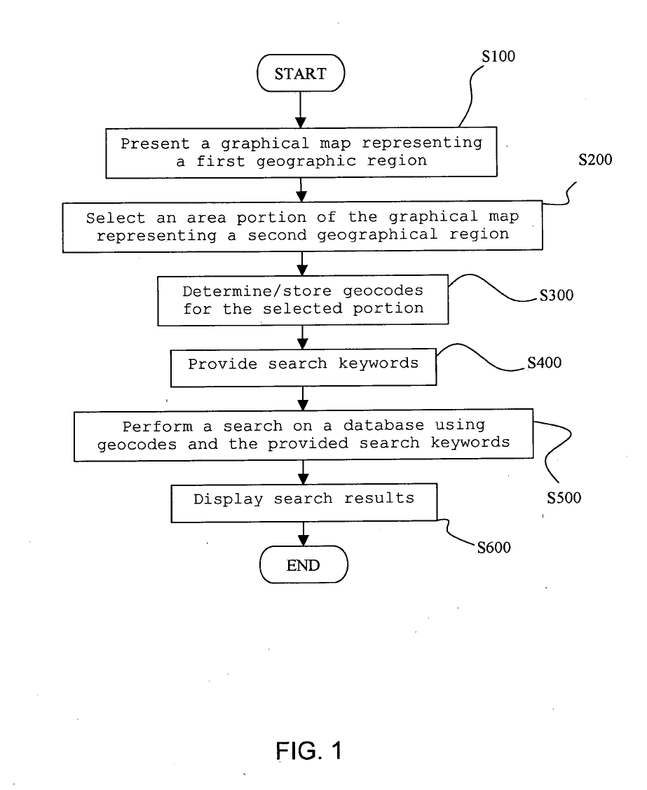

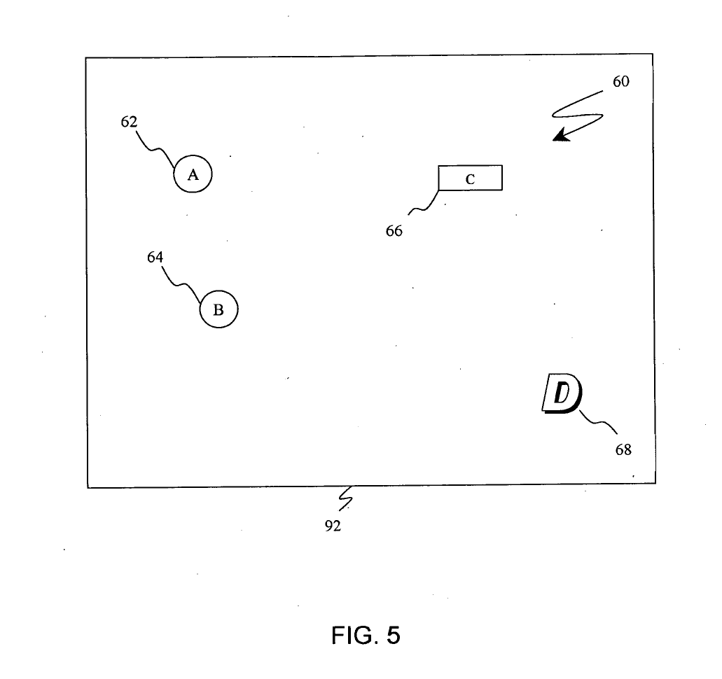

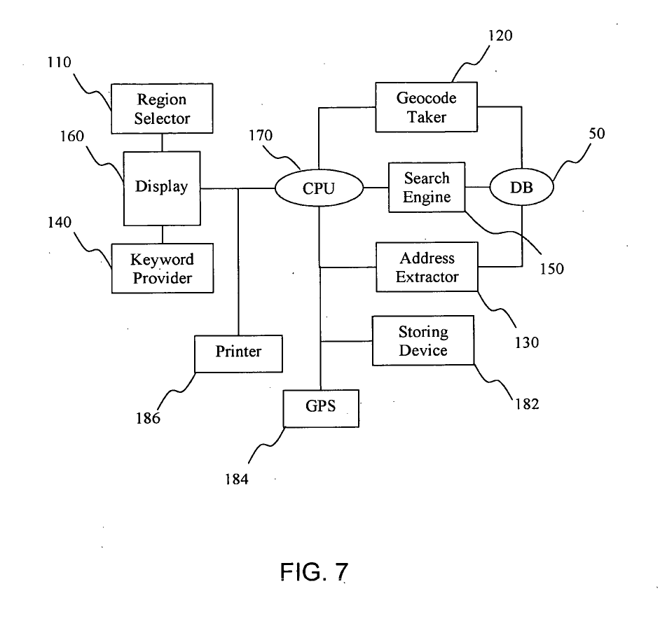

FIGS. 1-6 show a method for intuitive POI map search according to an embodiment of the invention. FIG. 7 shows a an intuitive POI map search system according to another embodiment of the invention.

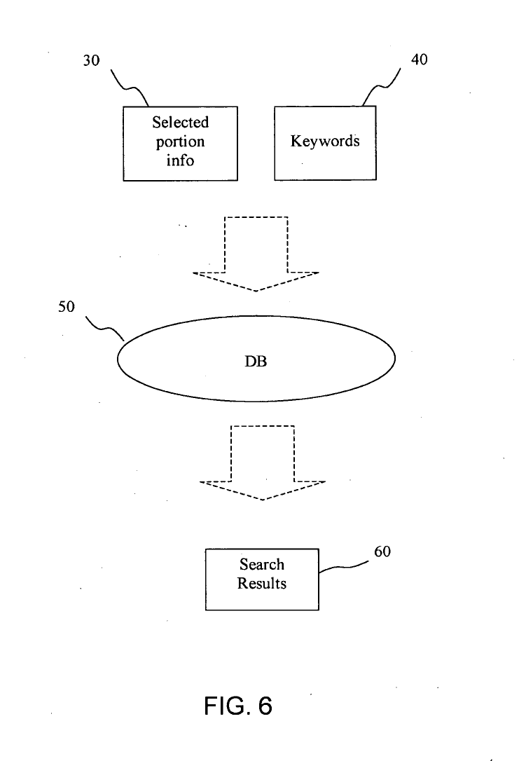

An aspect of the invention provides a method for intuitive POI map search. The method comprises steps of presenting a graphical map 10 representing a first geographic region 91 (S100), selecting an area portion 30 of the graphical map 10 representing a second geographical region 92 (S200), determining and storing geocodes for the selected area portion 30 (S300), providing a plurality of search keywords 40 (S400), performing a search on a database 50 using the stored geocodes and the provided search keywords 40 (S500), and displaying the search results 60 (S600) as shown in FIGS. 1 and 6.

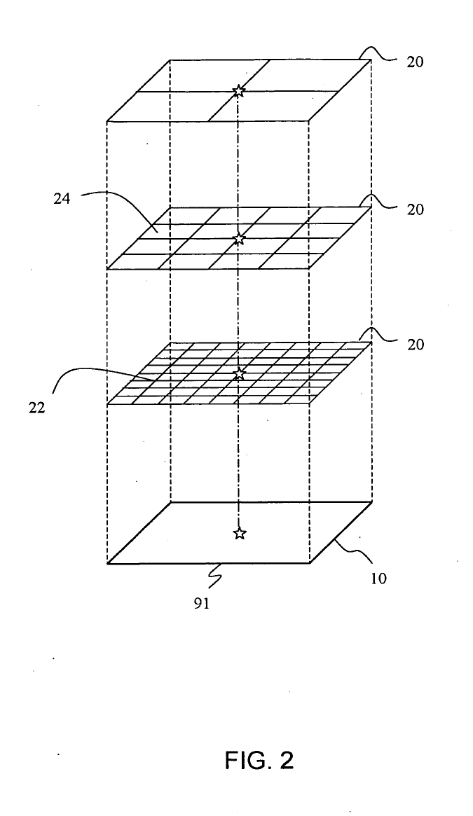

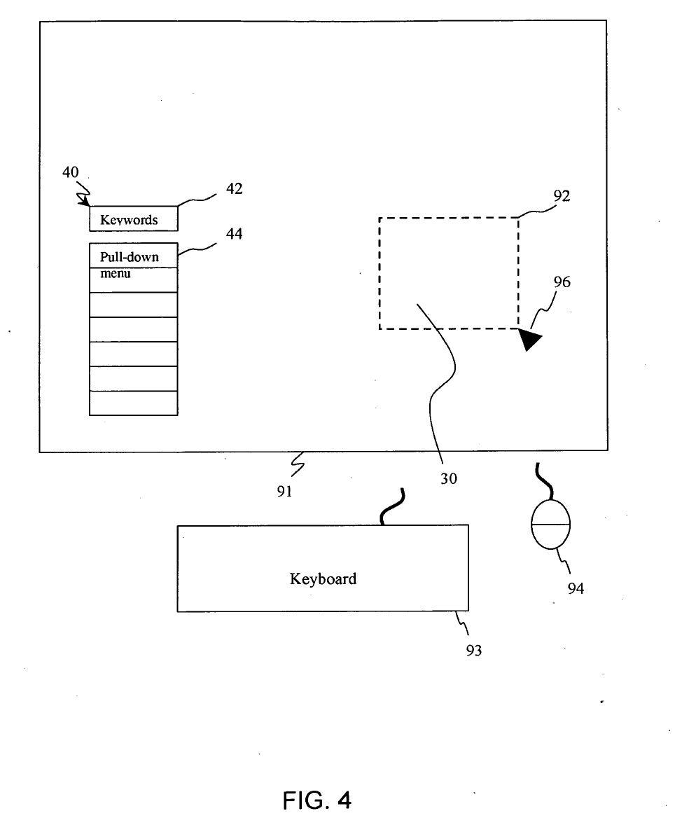

The step S100 of presenting the graphical map 10 is representing the first geographic region 91, for example, on a screen of a computer or a mobile communication device. For instance, the first geographical region 91 may be considered displayed on the screen of computer or mobile communication device in FIG. 4, in which a keyboard 93 and a mouse 94 may be associated with the computer or the mobile communication device. The graphical map 10 comprises embedded mesh 20 associated with coordinates, and a plurality of points 22 and sub-regions 24 of the embedded mesh 20 are mapped to a plurality of geocodes representing the first geographic region 91. The embedded mesh 20 is described conceptually in FIG. 2. The mesh 20 may be represented by a plurality of data structure such as an array or matrix of data fields. In certain embodiments of the invention, each of nodes on the mesh 20 is associated with information such as geocodes for a location in the graphical map 10 corresponding to the node. In the illustrated embodiment, a point on the mesh 20 (referred to as star symbols in FIG. 2) may belong to the plurality of meshes 20. Each of the mesh 20 can be used in enlarging or reducing a displayed portion of the graphical map 10 without sacrificing the details. In a specific resolution, a specific mesh 20 may be used, for example. A geocode (Geospatial Entity Object Code) is a representation format of a geospatial coordinate measurement used to provide a standard representation of an exact geospatial point location at, below, above the surface of the earth at a specified moment of time.

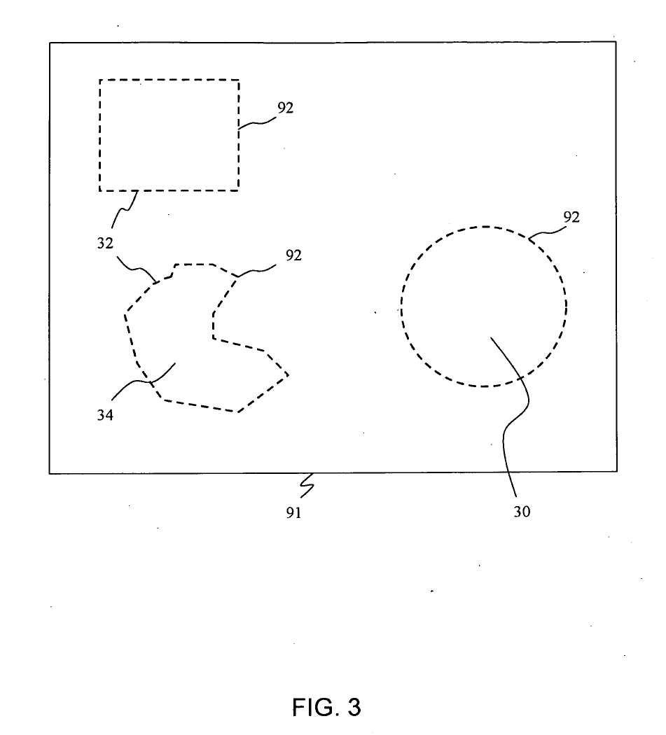

The step S200 of selecting is selecting a second geographical region 92, in which the map search is going to be interested or the search itself will be performed more intensively in that selected and reduced area 30. The second geographical region 92 comprises a sub-region of the first geographical region 91 as shown in FIG. 3.

The step S300 of determining and storing geocodes for the selected portion 30, each of the geocodes comprising a plurality of geospatial attributes. In certain embodiment of the invention, the geocodes mapped to all the points of the whole first geographical region 91 may be stored in a storing device in advance. Therefore, once the selected portion 30 is determined, the corresponding geocodes can be extracted from the storing device and kept in a separate location of the storing device or the database 50.

The step S400 of providing includes obtaining a plurality of search keywords 40 from a user and storing them in the storing device, or providing the plurality of search keywords 40 for a search engine 150, for example as shown in FIG. 7. In a prior art, the search engine used the keywords only to search for information in a database. However, the invention does not use the keywords only as disclosed below.

The step S500 of performing a search on the database 50 using the stored geocodes of the second geographical region 92 and the provided search keywords 40 as shown in FIG. 6. Therefore, the search engine 150 does not have to search all over the vast ocean of information on the database 50 or on the Internet, in which the search can be concentrated on the second geographical region 92.

The step S600 of displaying the search results 60, and the search results 60 comprises information on the second geographical region 92. The search result information on the second geographical region 92 may be displayed on the screen of the computer or the mobile communication device, replacing the original first geographical region 91.

The embedded mesh 20 may comprise a plurality of meshes of different resolutions, and the plurality of meshes of different resolutions may be mapped to one another as shown in FIG. 2. In certain embodiments of the invention, the mesh 20 may be realized in a form of data structure such as arrays, matrix, fields.

The step S100 of presenting may comprise a step of mapping the plurality of meshes of different resolutions to one another using a data structure. The mapping is used in enlarging or reducing the graphical map 50 in order to display the first geographical region 91 on the screen. The number of meshes 50 may be determined by a smallest geographical element of the graphical map 10.

The step S200 of selecting may comprise displaying the area portion 30 of the graphical map 10 using a plurality of border lines 32 as shown in FIG. 3. This way, the process of selecting can be displayed in real time.

Alternatively, the step S200 of selecting may comprise displaying the area portion of the graphical map 10 using a plurality of mosaic patterns 34 having different colors. In certain embodiments of the invention, the mosaic patterns 34 may be transparent.

The area portion 30 may have geometrical shapes, and the geometrical shapes may comprise a rectangle, a circle, an ellipse, and polygons as shown in FIG. 3.

Alternatively, the area portion 30 may have a plurality of irregular shapes as shown in FIG. 3. Each of the irregular shapes may represent a plurality of levels of administrative districts and service areas. Each of the administrative districts may be associated with a plurality of addresses corresponding to the first geographic region 91. In almost all the cases, administrative districts are not geometrical as the second geographical region 92 at the left-bottom of FIG. 3. In such cases, the database 50 itself may be organized following the irregular patterns of the administrative districts. For example, if the user wants to find a house in a specific school district, the second geographical region 92 would be definitely irregular, and the choices of possible second geographical regions 92 may be given already in the first geographical region 91 for the user to be able to choose by just clicking on one of those with a mouse 94 as shown in FIG. 4. That is, the second geographical regions 92 may be chosen by drawing a regular or irregular shape on the first geographical region 91 or by selecting one out of choices given on the first geographical region 91.

Each of the geometrical shapes may comprise a plurality of coordinates for points on the graphical map 10. The step S200 of selecting may comprise a step of defining the area portion 30 of the graphical map 10 with a mouse-and-cursor device 94, 96 as shown in FIG. 4. The step S200 of selecting may comprise a step of defining the area portion 30 of the graphical map 10 with a touch screen device (not shown).

Each of geocodes may correspond to a corresponding point on the geometrical map 10, and the spatial attributes may comprise a Geocode Format Registry Number, a latitude, a longitude, a altitude, a date, a local time, and a global time in coordinated universal time (UTC) format. Therefore, obtaining an address from a geocode and obtaining a geocode from an address for a location on the graphical map 10 may be very easily done on the database 50. The step S300 of determining may comprise converting a geocode to a corresponding address.

The step S400 of providing may comprise a step of providing the plurality of search keywords 40 using a keyboard 93, a touchpad (not shown), or a pull-down menu 44. The touchpad function may be performed directly on the screen. A keyword chosen from the pull-down menu 44 may be displayed in a small text window 42 as shown in FIG. 4. The database 50 may be organized according to geocodes, addresses, and a plurality of points of interest as discussed above.

The step S600 of displaying may comprise representing the plurality of points of interest with colors, symbols, or clickable texts or symbols, such that the user is able to recognize and manipulate the POIs on the screen. The colors may be chosen according to property of the points of interest.

The search results 60 may comprise a plurality of points of interest, and the plurality of points of interest may be represented by texts, symbols, or clickable buttons on the graphical map. The search keywords 40 may comprise categories, and wherein the database 50 is organized according to the categories and the search keywords. If the search keywords 40 were chosen from the pull-down menu 44, then there will no problem to use the search keywords 40 right away. However, if the keywords 44 were typed into the small text window 42 by the user, sometimes the type words may have to be transformed to use in the search on the database 50. And such transformation of the typed words to a usable search keywords 40 can be performed by a prior art conveniently.

The method may further comprise steps of: storing a plurality of search results 60 for a plurality of second geographical regions, wherein the plurality of search results 60 are obtained by repeating the step S500 of performing; and displaying at least one stored search result 60 of the plurality of search results 60 corresponding to a location where a user uses the method automatically. In certain embodiments of the invention, the automatic displaying of a search result corresponding a present location of the user may be set as a mode.

The step of displaying S600 may comprise a step of determining the location with a global positioning system (GPS). The GPS enables the automatic displaying of the above. In a different mode where a user selects a second geographical region 92 out of the first geographical region 91, the GPS may not be used.

The method may further comprise a step of printing the displayed search result 60 on a physical medium upon a request from the user. In certain embodiments of the invention, the user may wants to leave an environment where the method is being practiced (a car, for example) with a print out of the search results 60.

Another aspect of the invention provides an intuitive POI map search system, the system comprising a region selector 110, a geocode taker 120, an address extractor 130, a keyword provider 140, and a search engine 150 as shown in FIG. 7. The region selector 110 is configured for selecting a second geographic region 92 out of a first geographic region 91. The geocode taker 120 is configured for obtaining geocodes for a plurality of points inside the second geographic region 92.

The address extractor 130 is configured for obtaining addresses out of the corresponding geocodes for the plurality of points inside the second geographic region 92. The keyword provider 140 is configured for providing a plurality of search keywords 40. The search engine 150 is configured for performing one or more searches on the database 50 with the geocodes, the extracted address, and the search keywords for a plurality of points of interest in the second geographic region 92. The region selector 110 may comprise a mouse-and-cursor device or touch screen device as described before.

The system may further comprise a display 160 configured for displaying the graphical map 10 corresponding to the geographic regions 91, 92. The system may further comprise a central processing unit (CPU) 170 configured for controlling the region selector 110, the geocode taker 120, the address extractor 130, the keyword provider 140, the search engine 150, and the display 160. The region selector 110 may be further configured for defining the second geographic region 92 of geometrical shapes or irregular shapes. The region selector 110 may be further configured for selecting a plurality of separate points on the first geographic region 91 and forming the second geographic region 92 by connecting the selected separate points.

The region selector 110 may be further configured for selecting one out of predetermined set of sub-regions of the first geographic region 91, and the predetermined set of sub-regions may be provided and retrieved from the database 50. Each of the predetermined set of sub-regions may comprise an administrative district, a service area, or a demographic map. The geocodes and the corresponding addresses may be provided by the database 50. The plurality of search keywords 40 may be used for providing category words, class words, and subject words of the database 50 so as to be used by the search engine 150.

The intuitive POI map search system may further comprise: a global positioning system (GPS) 184 configured to determine a location of a user; a storing device 182 configured to store a plurality of search results 60 for a plurality of second geographical regions 192 from the search engine 150; a display 160 configured to display one of the stored search results 60 of a second geographical region 91 corresponding to a present location of the user automatically; and a printer 186 configured to print the displayed search result 60 of the second geographical region 92 as shown in FIG. 7. In certain embodiments of the invention, the storing device 182 may be combined with the DB 50.

While the invention has been disclosed with reference to embodiments thereof, it will be appreciated by those skilled in the art that variations in form, detail, compositions, and operation may be made without departing from the spirit and scope of the invention as defined by the accompanying claims.

What is claimed is:

1. A method for intuitive POI map search, comprising steps of:
presenting a graphical map representing a first geographic region, the graphical map comprising embedded mesh associated with coordinates, wherein a plurality of points and sub-regions of the embedded mesh are mapped to a plurality of geocodes representing the first geographic region;
selecting an area portion of the graphical map representing a second geographical region, wherein the second geographical region comprises a sub-region of the first geographical region;
determining and storing geocodes for the selected portion, each of the geocodes comprising a plurality of geospatial attributes;
providing a plurality of search keywords;
performing a search on a database using the stored geocodes and the provided search keywords; and
displaying the search results,
wherein the search results comprises information on the second geographical region.

2. The method of claim 1, wherein the embedded mesh comprises a plurality of meshes of different resolutions, and wherein the plurality of meshes of different resolutions are mapped to one another.

3. The method of claim 2, wherein the step of presenting comprises a step of mapping the plurality of meshes of different resolutions to one another using a data structure.

4. The method of claim 1, wherein the step of selecting comprises displaying the area portion of the graphical map using a plurality of border lines.

5. The method of claim 1, wherein the step of selecting comprises displaying the area portion of the graphical map using a plurality of mosaic patterns having different colors.

6. The method of claim 5, wherein the area portion has geometrical shapes, and wherein the geometrical shapes comprise a rectangle, a circle, an ellipse, and polygons.

7. The method of claim 5, wherein the area portion has a plurality of irregular shapes.

8. The method of claim 7, wherein each of the irregular shapes represents a plurality of levels of administrative districts and service areas.

9. The method of claim 8, wherein each of the administrative districts is associated with a plurality of addresses corresponding to the first geographic region.

10. The method of claim 6, wherein each of the geometrical shapes comprises a plurality of coordinates for points on the graphical map.

11. The method of claim 1, wherein the step of selecting comprises a step of defining the area portion of the graphical map with a mouse-and-cursor device.

12. The method of claim 1, wherein the step of selecting comprises a step of defining the area portion of the graphical map with a touch screen device.

13. The method of claim 1, wherein each of geocodes corresponds to a corresponding point on the geometrical map, and wherein the spatial attributes comprise a Geocode Format Registry Number, a latitude, a longitude, a altitude, a date, a local time, and a global time in coordinated universal time (UTC) format.

14. The method of claim 13, wherein the step of determining comprises converting a geocode to a corresponding address.

15. The method of claim 1, wherein the step of providing comprises a step of providing the plurality of search keywords using a keyboard, a touchpad, or a pull-down menu.

16. The method of claim 1, wherein the database is organized according to geocodes, addresses, and a plurality of points of interest.

17. The method of claim 1, wherein the step of displaying comprises representing the plurality of points of interest with colors, symbols, or clickable texts or symbols.

18. The method of claim 17, wherein the colors are chosen according to property of the points of interest.

19. The method of claim 1, wherein the search results comprises a plurality of points of interest, and wherein the plurality of points of interest are represented by texts, symbols, or clickable buttons on the graphical map.

20. The method of claim 1, wherein the search keywords comprise categories, and wherein the database is organized according to the categories and the search keywords.

21. The method of claim 1, further comprising steps of:
storing a plurality of search results for a plurality of second geographical regions, wherein the plurality of search results are obtained by repeating the step of performing; and
displaying automatically at least one stored search result of the plurality of search results corresponding to a location where a user uses the method.

22. The method of claim 21, wherein the step of displaying comprises a step of determining the location with a global positioning system (GPS).

23. The method of claim 21, further comprising a step of printing the displayed search result on a physical medium upon a request from the user.

24. An intuitive POI map search system, comprising:
a region selector configured for selecting a second geographic region out of a first geographic region;
a geocode taker configured for obtaining geocodes for a plurality of points inside the second geographic region;
an address extractor configured for obtaining addresses out of the corresponding geocodes for the plurality of points inside the second geographic region;
a keyword provider configured for providing a plurality of search keywords; and
a search engine configured for performing one or more searches on a database with the geocodes, the extracted address, and the search keywords for a plurality of points of interest in the second geographic region.

25. The intuitive POI map search system of claim 24, wherein the region selector comprises a mouse-and-cursor device or touch screen device.

26. The intuitive POI map search system of claim 25, further comprising a display configured for displaying a graphical map corresponding to the geographic regions.

27. The intuitive POI map search system of claim 26, further comprising a central processing unit configured for controlling the region selector, the geocode taker, the address extractor, the keyword provider, the search engine, and the display.

28. The intuitive POI map search system of claim 26, wherein the region selector is further configured for defining the second geographic region of geometrical shapes or irregular shapes.

29. The intuitive POI map search system of claim 26, wherein the region selector is further configured for selecting a plurality of separate points on the first geographic region and forming the second geographic region by connecting the selected separate points.

30. The intuitive POI map search system of claim 26, wherein the region selector is further configured for selecting one out of predetermined set of sub-regions of the first geographic region, wherein the predetermined set of sub-regions are provided and retrieved from the database.

31. The intuitive POI map search system of claim 30, wherein each of the predetermined set of sub-regions comprises an administrative district, a service area, or a demographic map.

32. The intuitive POI map search system of claim 24, wherein the geocodes and the corresponding addresses are provided by the database.

33. The intuitive POI map search system of claim 24, wherein the plurality of search keywords are used for providing category words, class words, and subject words of the database so as to be used by the search engine.

34. The intuitive POI map search system of claim 24, further comprising:
a global positioning system (GPS) configured to determine a location of a user;
a storing device configured to store a plurality of search results for a plurality of second geographical regions from the search engine;
a display configured to display one of the stored search results of a second geographical region corresponding to a present location of the user automatically; and
a printer configured to print the displayed search result of the second geographical region.
